(19) United States
(12) Patent Application Publication
(10) Pub. No.: US 2009/0322494 A1
(43) Pub. Date: Dec. 31, 2009

(54) CONTROLLING DEVICE AND SYSTEM

(76) Inventor: Chi-Ching LEE, Taoyuan Hsien (TW)

Correspondence Address: Muncy, Geissler, Olds & Lowe, PLLC, P.O. BOX 1364, FAIRFAX, VA, 22038-1364, US

(21) Appl. No.: 12/208,815

(22) Filed: Sep. 11, 2008

(30) Foreign Application Priority Data
Jun. 30, 2008 (TW) 097124508

(51) Int. Cl. G06F 17/00; G05B 11/01

(52) U.S. Cl. 340/310.13; 700/90; 320/101; 340/310.11

(57) ABSTRACT

A controlling device and a controlling system. The controlling device transmits controlling signals to an electronic device and receives operation statuses thereof through a power line. The controlling device includes a Human-Machine Interface (HMI) device for displaying the operation statuses of the electronic device. The controlling device includes a controller, an HMI device connected to the controller, a power supply for providing an electric power to the controller and the HMI device, and a power line network signal transmit/receive module connected to the controller.

### CROSS REFERENCE TO RELATED APPLICATIONS

This Non-provisional application claims priority under 35 U.S.C. §119(a) on Patent Application No(s). 097124508 filed in Taiwan, Republic of China on Jun. 30, 2008, the entire contents of which are hereby incorporated by reference.

### BACKGROUND OF THE INVENTION

1. Field of Invention

The present invention relates to a controlling device and a system. More particularly, the present invention relates to a controlling device and a system, which can control the electronic device and receive the operation statuses of the electronic device through a power line.

2. Related Art

The electronic devices, such as the household appliances, are usually controlled by remote controllers. The conventional remote controller utilizes the infrared ray (IR) to transmit signals. However, the remote controller has the limitation of direction of the infrared ray, and the signal transmission is easily blocked by walls. Thus, the application of the IR remote controller is usually restricted to a single room. In addition, the IR remote controller is usually a one-way controller so that the remote controller can not display the operation status of the electronic device. Moreover, each household appliance usually has a specific remote controller thereof, so each house usually has many remote controllers corresponding to multiple household appliances. This may cause inconvenience of the users.

### SUMMARY OF THE INVENTION

In view of the foregoing, the present invention is to provide a controlling device and a system that can integrate the remote controllers of general household appliances.

To achieve the above, the present invention discloses a controlling device including a controller, a Human-Machine Interface (HMI) device, a power supply and a power line network signal transmit/receive module. The HMI device is connected to the controller. The power supply provides an electric power to the controller and the HMI device, respectively. The power line network signal transmit/receive module is connected to the controller. The controlling device can control an electronic device through an external power line. The power supply can include a dry battery or a solar charging module.

In addition, the present invention also discloses a controlling system including a controlling device, an electronic device and a power line. The controlling device includes a first controller, a Human-Machine Interface (HMI) device, a power supply and a first power line network signal transmit/receive module. The HMI device is connected to the first controller. The power supply provides an electric power to the first controller and the HMI device, respectively. The first power line network signal transmit/receive module is connected to the first controller. The electronic device includes a second controller and a second power line network signal transmit/receive module, which is connected to the second controller. The power line is connected to the first and second power line network signal transmit/receive modules.

As mentioned above, in the controlling system of the present invention, the operation statuses of the electronic device can be transmitted from the second controller to the first controller through the second and first power line network signal transmit/receive modules. Then, the operation statuses can be displayed on the HMI device. Thus, the user can monitor the operation statuses of the electronic device via the controlling device. In addition, since the signal transmission between the controlling device and the electronic device can be performed through the power line, the application of the present invention is not restricted in a single room.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a schematic illustration showing a controlling device according to an embodiment of the present invention;

FIG. 2 is a schematic illustration showing a controlling system according to an embodiment of the present invention; and

FIG. 3 is a schematic illustration showing an application of the controlling system of FIG. 2.

### DETAILED DESCRIPTION OF THE INVENTION

The present invention will be apparent from the following detailed description, which proceeds with reference to the accompanying drawings, wherein the same references relate to the same elements.

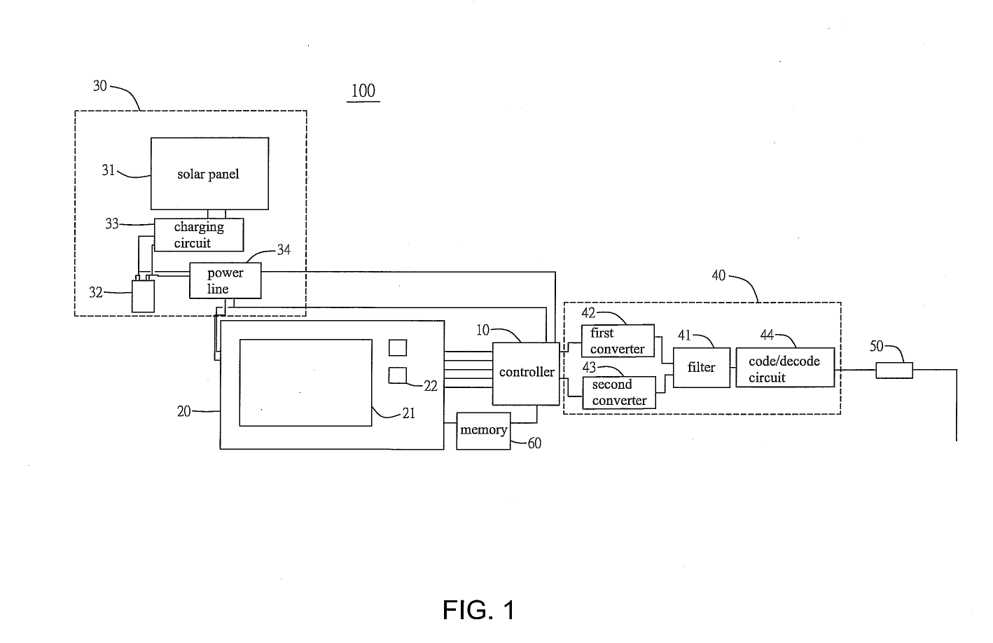

FIG. 1 is a schematic illustration showing a controlling device 100 according to an embodiment of the present invention. The controlling device 100 includes a controller 10, a Human-Machine Interface (HMI) device 20, a power supply 30 and a power line network signal transmit/receive module 40. The HMI device 20 is connected to the controller 10. The power supply 30 provides an electric power to the controller 10 and the HMI device 20, respectively. The power line network signal transmit/receive module 40 is connected to the controller 10.

The power supply 30 can include a dry battery or a solar charging module. FIG. 1 shows an aspect of the power supply 30, which is a solar charging module. In the embodiment, the power supply 30 includes a solar panel 31, a battery 32, a charging circuit 33 and a power line 34. The charging circuit 33 is connected to the solar panel 31 and the battery 32 so that the electric power generated by the solar panel 31 can be transmitted to and stored in the battery 32. The power line 34 transmits the electric power from the battery 32 to the controller 10 and the HMI device 20.

In the embodiment, the power line network signal transmit/receive module 40 communicates with external through a power socket 50. The power line network signal transmit/receive module 40 includes a filter 41, a first converter 42, a second converter 43 and a code/decode circuit 44. The first and second converters 42, 43 are connected with each other in parallel and connected to the filter 41 and the controller 10, respectively. The code/decode circuit 44 is connected to the filter 41 and the power socket 50. The first converter 42 can be an input signal converter for receiving an analog signal from the controller 10 and converting the analog signal into a digital signal, which is then transmitted to the code/decode circuit 44 through the filter 41 for coding. The second converter 43 can be an output signal converter for receiving a digital signal from the code/decode circuit 44, which decodes the digital signal, through the filter 41, and converting the decoded digital signal into an analog signal, which is then transmitted to the controller 10.

In the embodiment, the HMI device 20 includes a monitor 21 and at least one button 22. Alternatively, the HMI device 20 can be a touch panel. A memory 60 is connected to the controller 10 and the HMI device 20 for storing the information shown on the HMI device 20. When the controlling device 100 receives the external signals, which is transmitted through the power line, from the power socket 50, the external signals can be displayed on the HMI device 20 through the power line network signal transmit/receive module 40 and the controller 10. Furthermore, the user can press the button or the touch panel for issuing an instruction through the HMI device 20, and then the instruction can be transmitted to external through the controller 10 and the power line network signal transmit/receive module 40.

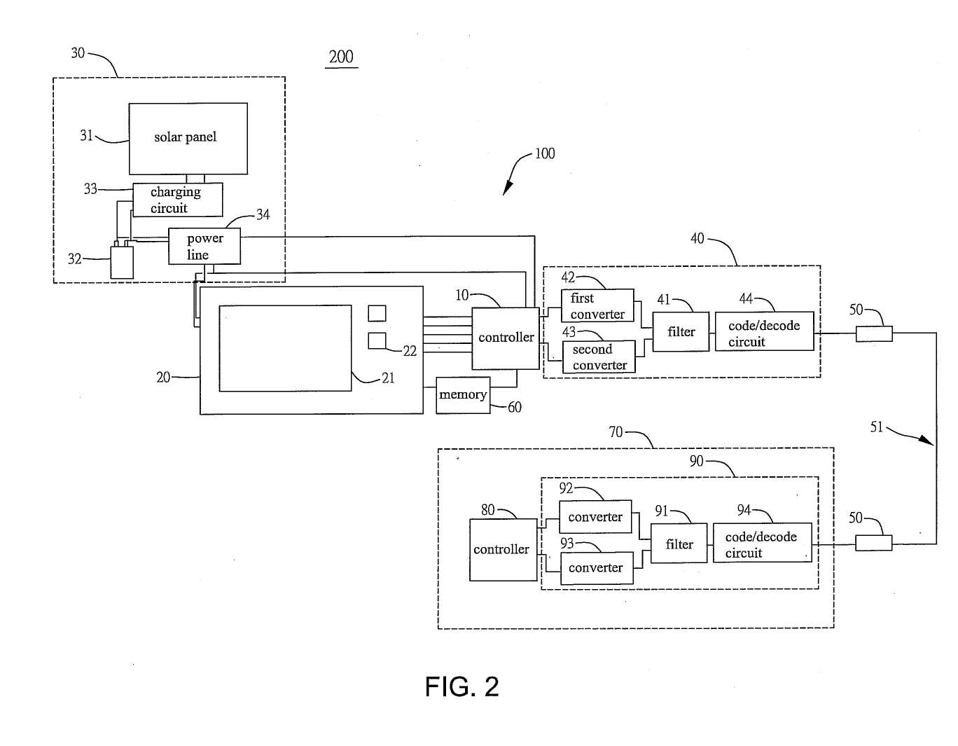

FIG. 2 is a schematic illustration showing a controlling system 200 according to an embodiment of the present invention. In the controlling system 200, the controlling device 100 is connected to an electronic device 70 through a power line 51. The electronic device 70 includes a controller 80 and a power line network signal transmit/receive module 90, which are connected to each other. The power line network signal transmit/receive module 90 of the electronic device 70 is connected to the power line network signal transmit/receive module 40 of the controlling device 100 through the power line 51. The power line network signal transmit/receive module 90 includes a filter 91, a converter 92, a converter 93 and a code/decode circuit 94. The converters 92 and 93 are connected with each other in parallel and connected to the filter 91 and the controller 80, respectively. The code/decode circuit 94 is connected to the filter 91 and the power line 51. The function of the power line network signal transmit/receive module 90 of the electronic device 70 is the same as that of the power line network signal transmit/receive module 40 of the controlling device 100, so the detailed descriptions thereof will be omitted.

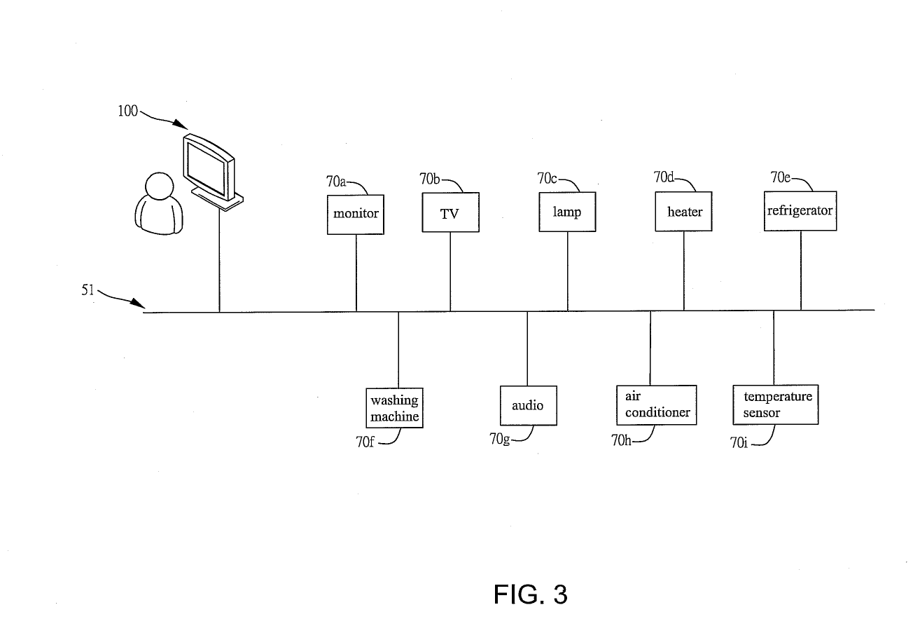

With reference to FIGS. 2 and 3, the electronic device 70 can be, as shown in FIG. 3, a monitor 70a, a television 70b, lamp 70c, a heater 70d, a refrigerator 70e, a washing machine 70f, an audio 70g, an air conditioner 70h or a temperature sensor 70i. If the electronic device 70 is a washing machine, the operation statuses thereof can be transmitted to the controlling device 100 through the controller 80, the power line network signal transmit/receive module 90 and the power line 51, decoded by the power line network signal transmit/receive module 40, and then displayed on the HMI device 20 through the controller 10. Alternatively, an instruction signal, such as a shut down instruction signal, can be transmitted from the HMI device 20 to the electronic device 70 through the controller 10, the power line network signal transmit/receive module 40 and the power line 51. After receiving the instruction signal, the controller 80 can control the electronic device 70 according to the instruction signal.

In the present invention, the instruction signal between the controlling device and the electronic device can be transmitted through, for example but not limited to, a power line communication (PLC) protocol.

In summary, the controlling device and system of the present invention can integrate the remote control functions for multiple electronic devices and display the operation statuses of the electronic devices. In addition, the signal transmission of the present invention can be performed through the power line, so the additional transmission wires or lines are not needed.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A controlling device comprising:
a controller;
a Human-Machine Interface device connected to the controller;
a power supply for providing an electric power to the controller and the Human-Machine Interface device, respectively; and
a power line network signal transmit/receive module connected to the controller.

2. The controlling device according to claim 1, wherein the power supply comprises a dry battery or a solar charging module.

3. The controlling device according to claim 1, wherein the power supply comprises a solar panel, a battery, a charging circuit and a power line, the charging circuit is connected to the solar panel and the battery, and the power line transmits the electric power from the battery to the controller and the Human-Machine Interface device.

4. The controlling device according to claim 1, wherein the power line network signal transmit/receive module communicates with external through a power socket.

5. The controlling device according to claim 4, wherein the power line network signal transmit/receive module comprises:
a filter;
a first converter and a second converter, both of which are connected with each other in parallel and connected to the filter and the controller, respectively; and
a code/decode circuit connected to the filter and the power socket.

6. The controlling device according to claim 5, wherein the first converter receives an analog signal from the controller and converts the analog signal into a digital signal, and then the digital signal is transmitted to the code/decode circuit through the filter for coding.

7. The controlling device according to claim 5, wherein the second converter receives a digital signal from the code/decode circuit through the filter, the digital signal is decoded by the code/decode circuit and converted into an analog signal by the second converter, and the analog signal is transmitted to the controller.

8. The controlling device according to claim 1, wherein the Human-Machine Interface device comprises a monitor, at least one button or a touch panel.

9. The controlling device according to claim 8, further comprising a memory connected to the controller and the Human-Machine Interface device.

10. A controlling system, comprising:
a controlling device comprising:
a first controller,
a Human-Machine Interface device connected to the first controller,
a power supply for providing an electric power to the first controller and the Human-Machine Interface device, respectively, and
a first power line network signal transmit/receive module connected to the first controller; and
an electronic device comprising:
a second controller,
a second power line network signal transmit/receive module connected to the second controller, and
a power line connected to the first power line network signal transmit/receive module and the second power line network signal transmit/receive module.

11. The controlling system according to claim 10, wherein the second controller transmits an operation status of the electronic device from the second power line network signal transmit/receive module to the first power line network signal transmit/receive module.

12. The controlling system according to claim 11, wherein the operation status is further transmitted from the first power line network signal transmit/receive module to the first controller so as to be displayed on the Human-Machine Interface device.

13. The controlling system according to claim 10, wherein the power supply comprises a solar panel, a battery, a charging circuit and a power line, the charging circuit is connected to the solar panel and the battery, and the power line transmits the electric power from the battery to the controller and the Human-Machine Interface device.

14. The controlling system according to claim 10, wherein the first power line network signal transmit/receive module comprises:
a first filter;
a first converter and a second converter, both of which are connected with each other in parallel and connected to the first filter and the first controller, respectively; and
a first code/decode circuit connected to the first filter and the power line.

15. The controlling system according to claim 14, wherein the first converter receives an analog signal from the first controller and converts the analog signal into a digital signal, and then the digital signal is transmitted to the first code/decode circuit through the first filter for coding.

16. The controlling system according to claim 14, wherein the second converter receives a digital signal from the first code/decode circuit through the first filter, the digital signal is decoded by the first code/decode circuit and converted into an analog signal by the second converter, and the analog signal is transmitted to the first controller.

17. The controlling system according to claim 10, wherein the second power line network signal transmit/receive module comprises:
a second filter;
a third converter and a fourth converter, both of which are connected with each other in parallel and connected to the second filter and the second controller, respectively; and
a second code/decode circuit connected to the second filter and the power line.

18. The controlling system according to claim 17, wherein the third converter receives an analog signal from the second controller and converts the analog signal into a digital signal, and then the digital signal is transmitted to the second code/decode circuit through the second filter for coding.

19. The controlling system according to claim 18, wherein the fourth converter receives a digital signal from the second code/decode circuit through the second filter, the digital signal is decoded by the second code/decode circuit and converted into an analog signal by the second converter, and the analog signal is transmitted to the second controller.

20. The controlling system according to claim 10, wherein the electronic device comprises a monitor, a television, lamp, a temperature sensor, a heater, an air conditioner, an audio, a refrigerator or a washing machine.

21. The controlling system according to claim 10, wherein the controlling device and the electronic device are communicated through a power line communication protocol.

22. The controlling system according to claim 10, wherein the Human-Machine Interface device generates an instruction signal, and the second controller receives the instruction signal so as to control the electronic device.
